(19) United States
(12) Patent Application Publication
(10) Pub. No.: US 2011/0038990 A1
(43) Pub. Date: Feb. 17, 2011

(54) FOOD COOKING APPARATUS AND OPERATION METHOD THEREOF

(76) Inventor: Suk Hyun, Seoul (KR)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/833,566

(22) Filed: Jul. 9, 2010

(30) Foreign Application Priority Data
Aug. 14, 2009 (KR) 10-2009-0075100

(51) Int. Cl. A23B 4/056; F24C 7/04; A47J 36/00; F24C 15/00; A47J 27/04; F24C 7/08; F24C 15/22

(52) U.S. Cl. 426/235; 99/451; 99/446; 99/482; 99/473; 99/448; 426/523

(57) ABSTRACT

A food cooking apparatus includes: a main body having a cooking room therein; a rotation motor transmitting power to a rotating shaft disposed in the cooking room to rotate the rotating shaft; a plurality of rotating plates being connected to the rotating shaft and rotating by interlocking with the rotation of the rotating shaft; a holder detachably formed on the tops of the rotating plates; and a plurality of heaters disposed on the inner side surfaces of the cooking room to generate heat.

### BACKGROUND

1. Field of the Invention

The present invention relates to a food cooking apparatus and an operation method of the food cooking apparatus.

2. Description of the Related Art

In general, chicken has been recognized as a nourishing food used by a lot of persons. The chicken is high in protein content and essential fatty acid content, but low in fat and calorie in comparison with other meats, whereby the chicken has been recognized as an excellent health food. In addition, the chicken is low in cost, fast to cook, smooth to chew, high in digestion rate, good in scent, and excellent in harmony with other spices or foods, in comparison with other meats.

A variety of cooking methods for the chicken have been developed, so that the chicken can meet various persons' tastes from children to olds. Fried chicken is the representative food using chicken, which means a food cooked by cutting a chicken, coating the cut pieces with kneaded frying powder, and frying the resultant in heated oil.

The chicken is cooked using methods of frying it in oil, boiling it in water, heating it directly with fire. For example, the fried chicken is cooked using a method of coating meat boundaries with paste and frying the meat in oil, a method of coating meat boundaries with powder instead of the paste and frying the meat in oil, a method of coating meat boundaries with paste, applying powder thereon, and frying the meat in oil, and the like. In such fried chicken, the cooked powder or paste parts of the surfaces provide a crunch feeling and the internal meat provides a moist feeling, so that many persons enjoy the food.

However, when chicken is cooked using the above-mentioned methods, the meat quality of breasts or the like is not chewy but brittle, thereby causing a problem with chicken made tasteless. Accordingly, there is a need for a food cooking apparatus and an operation method thereof, which can cook chicken using beer so that the meat quality of breasts or the like is chewy, smooth, and tasty, and can sanitarily cook chicken in mass without burning or half-cooking the chicken.

### SUMMARY

An advantage of some aspects of the invention is that it provides a food cooking apparatus and an operation method thereof which can cook foods to be smooth and tasty by vaporizing and permeating beer into the foods.

Another advantage of some aspects of the invention is that it provides a food cooking apparatus and an operation method thereof which can cook foods in mass using plural holders placed on plural rotating plates.

Another advantage of some aspects of the invention is that it provides a food cooking apparatus and an operation method thereof which can shorten the cooking time by cooking foods using near-infrared rays applied from a near-infrared lamp.

Another advantage of some aspects of the invention is that it provides a food cooking apparatus and an operation method thereof which can sanitarily cook foods by preventing fat discharged from the foods from flowing to the outside by the use of a fat receiver disposed in the holders.

Another advantage of some aspects of the invention is that it provides a food cooking apparatus and an operation method thereof which can fast and evenly cook foods by reflecting near-infrared rays applied from a near-infrared lamp using a reflecting plate to minimize the consumption of near-infrared rays.

Another advantage of some aspects of the invention is that it provides a food cooking apparatus and an operation method thereof which can cook foods appropriately without burning or half-cooking the foods by adjusting brightness of near-infrared lamps using plural dimmers.

Advantage of the invention are not limited to the above-mentioned, and other advantages can be apparently understood from the following description by those skilled in the art.

According to an aspect of the invention, there is provided a food cooking apparatus including: a main body having a cooking room therein; a rotation motor transmitting power to a rotating shaft disposed in the cooking room to rotate the rotating shaft; a plurality of rotating plates being connected to the rotating shaft and rotating by interlocking with the rotation of the rotating shaft; a holder detachably formed on the tops of the rotating plates; and a plurality of heaters disposed on the inner side surfaces of the cooking room to generate heat.

According to another aspect of the invention, there is provided an operation method of a food cooking apparatus, including the steps of: transmitting power to a rotating shaft disposed in a cooking room in a main body from a rotation motor to rotate the plurality of rotating plates connected to the rotating shaft; and applying heat to the food fixed to the holder detachably placed on the top of each rotating plate by the use of a heater.

Details of other aspects are included in the detailed description and the accompanying drawings.

Advantages and features of the invention and methods for putting them into practice will be apparent from the following embodiments and drawings. However, the invention is not limited to the embodiments, but can be modified in various forms. The embodiments are provided to complete the disclosure of the invention and to completely notify the scope of the invention to those skilled in the art. Like reference numerals in the drawings reference like elements. In the following description, like elements are referenced by like reference numerals or signs.

According to the above-mentioned configuration, it is possible to cook foods to be smooth and tasty by vaporizing and permeating beer into the foods.

According to the above-mentioned configuration, it is possible to cook foods in mass using plural holders placed on plural rotating plates.

According to the above-mentioned configuration, it is possible to shorten the cooking time by cooking foods using near-infrared rays applied from a near-infrared lamp.

According to the above-mentioned configuration, it is possible to sanitarily cook foods by preventing fat discharged from the foods from flowing to the outside by the use of a fat receiver disposed in the holders.

According to the above-mentioned configuration, it is possible to faster cook foods by reflecting near-infrared rays applied from a near-infrared lamp using a reflecting plate to minimize the consumption of near-infrared rays.

According to the above-mentioned configuration, it is possible to cook foods using a cooking method of exposing the foods to smoke, that is, a smoking method, by combusting a smoking material contained in a smoking material combustion drawer using near-infrared rays applied from a near-infrared lamp and introducing smoke generated by the combustion of the smoking material into a cooking room through a introduction hole.

According to the above-mentioned configuration, it is possible to add moisture to foods and thus to prevent the foods from drying, by vaporizing water contained in the smoking material combustion drawer into steam by the combustion of the smoking material and then introducing the steam into the cooking room through the introduction hole.

According to the above-mentioned configuration, it is possible to cook foods appropriately without burning or half-cooking the foods by adjusting brightness of near-infrared lamps using plural dimmers.

According to the above-mentioned configuration, it is possible to cook sausages or the like at the same time as cooking chicken, duck, and the like by hanging foods on food hangers formed at the edges of the rotating plates.

According to the above-mentioned configuration, it is possible to block the near-infrared rays applied from other near-infrared lamps, that is, the reflected near-infrared rays and to concentrate the near-infrared rays on the foods, by applying a ruby coating the inside or outside of the near-infrared lamp.

According to the above-mentioned configuration, it is possible to easily remove foreign materials when the foreign materials such as fat are attached to the near-infrared lamp, by applying a ruby coating the inside or outside of the near-infrared lamp.

According to the above-mentioned configuration, it is possible to cook pork belly, ribs, fish, and the like at the same time as cooking chicken, duck, and the like, by the use of a stand having plural container spaces.

### BRIEF DESCRIPTION OF THE DRAWINGS

FIG. 1 is a perspective view illustrating a food cooking apparatus according to an embodiment of the invention.

FIG. 2 is a front view of the food cooking apparatus according to the embodiment of the invention.

FIG. 3 is a side view illustrating the internal configuration of the food cooking apparatus according to the embodiment of the invention.

FIG. 4 is a diagram illustrating the detailed configuration of a holder shown in FIG. 1.

FIG. 5 is a diagram illustrating a stand disposed in the food cooking apparatus according to the embodiment of the invention.

FIG. 6 is a flowchart illustrating a flow of an operation method of the food cooking apparatus according to the embodiment of the invention.

### DESCRIPTION OF EXEMPLARY EMBODIMENTS

A food cooking apparatus according to an embodiment of the invention can cook foods fixed to holders detachably placed on rotating plates by generating heat. Here, the food cooking apparatus can include a near-infrared lamp or a gas heater as a heating device.

It is assumed in this specification that the near-infrared lamp is used as the heating device. This is intended for convenient explanation and easy understanding, but not intended to limit the invention.

The gas heater is a heater generating heat using gas and can be embodied, for example, by a Braun gas heater using a thermonuclear reaction. The Braun gas heater can be supplied with Braun gas from a Braun gas generator and generate heat by combusting the supplied Braun gas with a burner.

Hereinafter, exemplary embodiments of the invention will be described in detail with reference to the accompanying drawings.

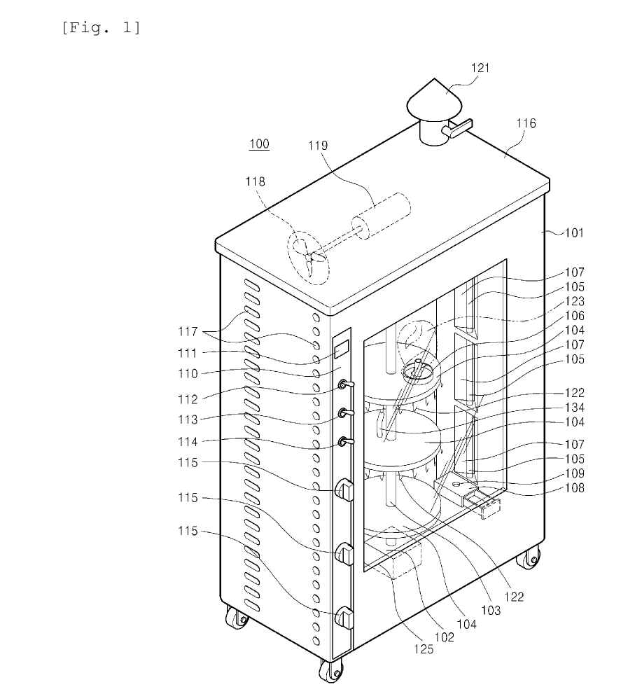

FIG. 1 is a perspective view illustrating a food cooking apparatus according to an embodiment of the invention.

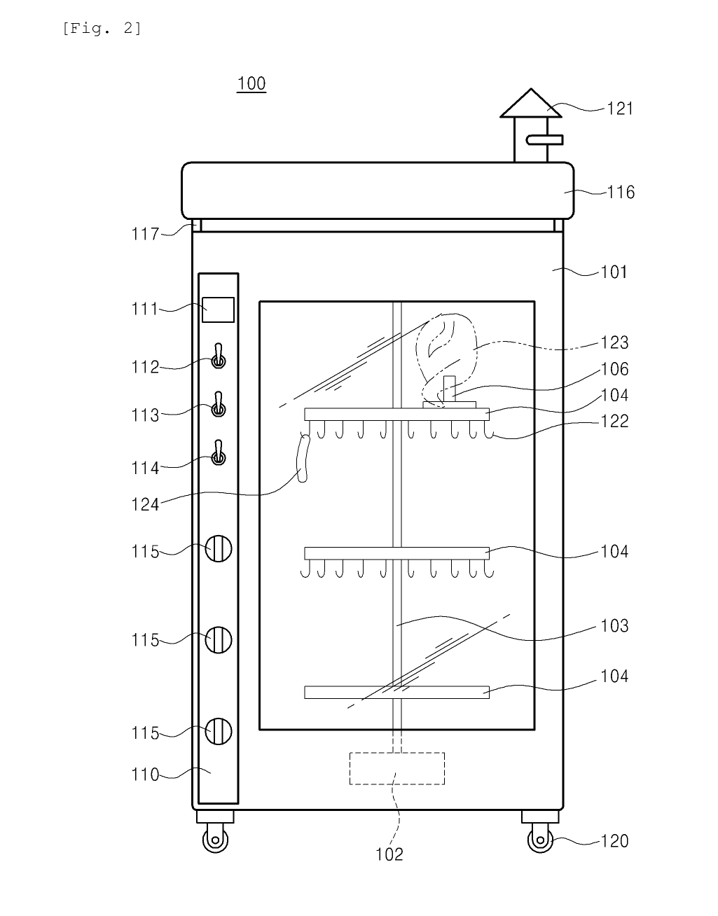

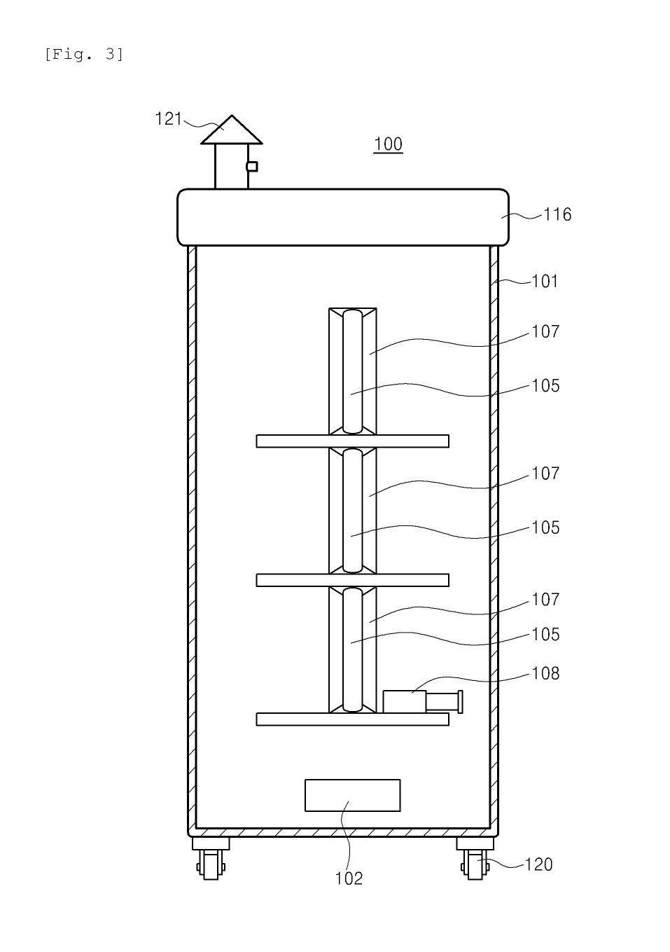

FIG. 2 is a front view of the food cooking apparatus according to the embodiment of the invention. FIG. 3 is a side view illustrating the internal configuration of the food cooking apparatus according to the embodiment of the invention.

As shown in FIGS. 1 to 3, the food cooking apparatus 100 according to the embodiment of the invention includes a main body 101, a rotation motor 102, plural rotating plates 104, near-infrared lamps 105, holders 106, reflecting plates 107, a smoking material combustion drawer 108, a control box 110, and a cover 116.

The main body 101 includes a cooking room in its internal space. The rotating plates 104, the near-infrared lamps 105, the holders 106, the reflecting plates 107, and the smoking material combustion drawer 108 are disposed in the cooking room. The main body 101 is formed of stainless steel which is rust-proof to prevent corrosion and excellent in strength.

The rotation motor 102 transmits power to a rotating shaft 103 disposed in the cooking room to rotate the rotating shaft 103. The rotation motor 102 is disposed in the lower portion of the main body 101, but is not limited to this position and may be disposed at other positions in the main body.

The rotating plates 104 are connected to the rotating shaft 103 and rotate by interlocking with the rotation of the rotating shaft 103. Here, the rotating shaft 103 is vertically disposed in the cooking room in the main body 101. The rotating plates 104 are disposed at a constant interval in the direction perpendicular to the rotating shaft 103, that is, in the horizontal direction.

The rotating plates 104 have a disk shape, but may have various other shapes such as rectangles and polygons. Plural (for example, eight to the maximum) holders 106 to which foods 123 are fixed are placed on the rotating plates 104. Accordingly, for example, 24 chickens or ducks to the maximum can be placed on the rotating plates 104.

Food hangers 122 are attached to the edges of the rotating plates 104 so as to hang foods thereon. Here, the foods hangers 122 have a ring shape. A user can hang foods such as sausages on the food hangers 122 to cook the foods.

The near-infrared lamps 105 are disposed on the inner side surface of the cooking room and emit near-infrared rays. At this time, the near-infrared lamps 105 are arranged to correspond to the rotating plates 104, respectively. Accordingly, by directly applying the near-infrared rays to the foods 123 such as chickens or ducks placed on the rotating plates 104, it is possible to cook the foods rapidly (for example, the cooking time is 15 to 20 minutes).

The near-infrared lamps 105 are disposed on both side surfaces of the cooking room and evenly cook the inside and outside of the foods 123 by evenly applying the near-infrared rays to the foods 123.

The holder 106 can be attached to and detached from each rotating plate 104. The holder 106 is formed of stainless steel which is rust-proof to prevent the corrosion and excellent in strength.

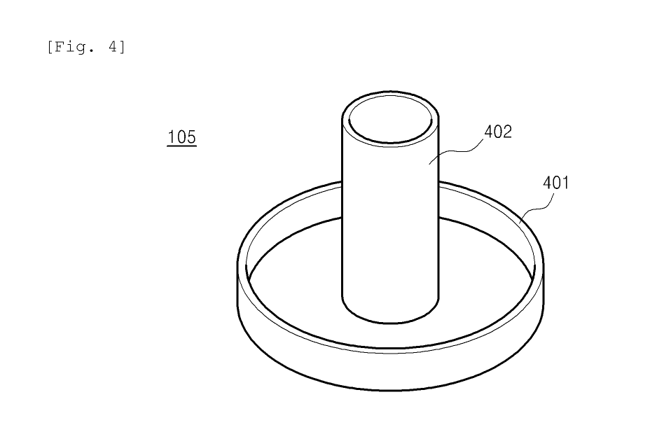

As shown in FIG. 4, each holder 106 includes a fat receiver 401 receiving the fat discharged from the foods and a beer container 402 which is formed on the fat receiver 401, which contains beer so as to vaporize the beer by the near-infrared rays, and which fixes the foods thereto.

In this way, since the fat receiver 401 of the holder 106 prevents the fat discharged from the foods from flowing out, it is possible to cook the foods sanitarily. The fat receiver 401 causes a user to recover the fat easily and conveniently.

Since the beer container 402 causes the beer contained therein to be vaporized by the near-infrared rays, the beer permeates the foods to make the foods smooth and tasty.

The reflecting plate 107 is disposed between each near-infrared lamp 105 and the side surface of the main body 101 and is opened toward the near-infrared lamp 105 so as to surround a part of the near-infrared lamp 105. The reflecting plate 107 is formed of a material reflecting the near-infrared rays applied from the near-infrared lamp 105 well, for example, aluminum.

The smoking material combustion drawer 108 has a drawer shape containing the smoking material therein. Therefore, a user can add or remove the smoking material to and from the smoking material combustion drawer. The smoking material combustion drawer 108 is disposed in front of the near-infrared lamp 105 disposed at the lowermost out of the near-infrared lamps 105 and can combust the smoking material using the near-infrared rays applied from the near-infrared lamp 105.

An introduction hole formed through the smoking material combustion drawer 108 is formed in the top of the smoking material combustion drawer 108. The smoke generated by the combustion of the smoking material is introduced into the cooking room via the introduction hole 109. Accordingly, the foods 123 can be cooked using a cooking method of exposing the foods 123 to the smoke, that is, a smoking method.

Water along with the smoking material may be additionally contained in the smoking material combustion drawer. In this case, the water is vaporized in steam by the combustion of the smoking material and is introduced into the cooking room via the introduction hole 109. Therefore, moisture is added to the foods, thereby preventing the foods 123 from drying.

The control box 110 is disposed on the front surface of the main body 101 to control the operations of the food cooking apparatus 100. The control box 110 includes a digital thermometer 111, a power switch 112, a rotation switch 113, a room light switch 114, and plural dimmers 115.

The digital thermometer 111 is disposed in the upper portion of the control box 110 and serves to measure the temperature of the cooking room and to display the measured temperature digitally. The digital thermometer 111 activates or deactivates the near-infrared lamps 105 depending on the measured temperature.

For example, when the temperature of the cooking room is higher than 300° C., the digital thermometer 111 deactivates the near-infrared lamps 105. When the temperature of the cooking room is lower than 300° C., the digital thermometer 111 activates the near-infrared lamp 106. Therefore, the digital thermometer 111 serves to keep the temperature of the cooking room in a constant range, thereby cooking the foods appropriately without burning or half-cooking the foods.

The power switch 112 is disposed below the digital thermometer 111. The power switch 112 turns on or off the food cooking apparatus 100 depending on a user's operation.

The rotation switch 113 is disposed below the power switch 112. The rotation switch 113 turns on or off the rotation motor 102.

The room light switch 114 is disposed below the rotation switch 113. The room light switch 114 turns on or off a room light (not shown) disposed in the main body 101 to light the cooking room.

The plural dimmers 115 are disposed below the room light switch 114. The dimmers 115 serve to adjust the brightness of the near-infrared lamps 105 by the user's operation. Therefore, the user can cook the foods 123 appropriately without burning or half-cooking the foods using the dimmers 115.

The number of dimmers 115 may correspond to the number of near-infrared lamps 105. The dimmers 115 may be disposed at positions corresponding to the near-infrared lamps 105. This is because the user can more easily activate the near-infrared lamps 105.

On the other hand, the dimmers 115 may include a display lamp (not shown) displaying the operating states of the near-infrared lamps 105 when the near-infrared lamps 105 are operated by the user. For example, the display lamp may output green light when the corresponding near-infrared lamp 105 is activated, while the display lamp may output red light when the corresponding near-infrared lamp 105 is deactivated.

The cover 116 is formed on the top of the main body 101 and covers the top of the main body 101. A water-proof roof (not shown) preventing water from permeating the main body 101 may be disposed on the top of the cover 116.

The food cooking apparatus 100 further includes plural heat-dissipating holes 117, a fan 118, a fan motor 119, casters 120, and a door 125.

The heat-dissipating holes 117 are formed in the side surface of the main body 101.

The fan 118 serves to discharge the heat generated in the cooking room to the outside of the food cooking apparatus 100 via the heat-dissipating holes 117.

The fan motor 119 transmits power to the fan 118 to rotate the fan 118.

The casters 120 are disposed on the bottom of the main body 101 so as to move the main body 101.

The door 125 is formed of a transparent and strong material such as reinforced glass and is disposed on the front and/or back surface of the main body 101.

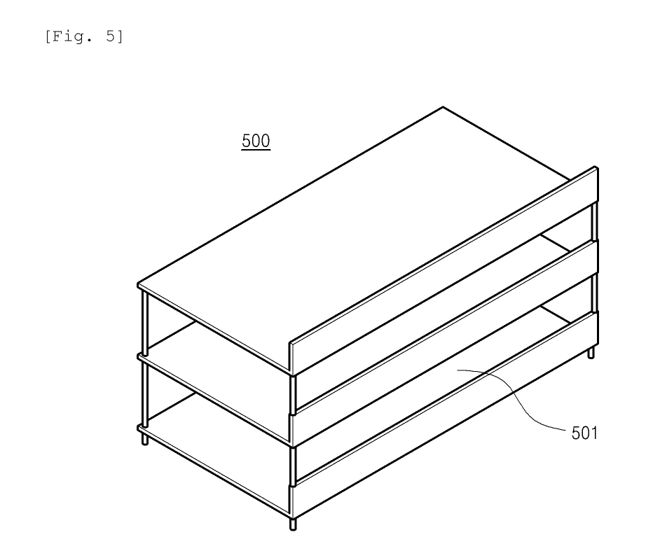

On the other hand, the food cooking apparatus 100 may further include a stand 500 having plural container spaces 501 into which foods can be put, as shown in FIG. 5. The stand 500 is formed of stainless steel and is disposed in the cooking room. The stand 500 can be located on the rotating plates 104 or below the lowermost rotating plate 104, that is, in the lower portion of the main body 101.

Pork belly, ribs, fish, and the like can be contained in the container spaces 501. Accordingly, a user can cook pork belly, ribs, fish, and the like at the same time as cooking chickens, ducks, and the like using the plural container spaces 501.

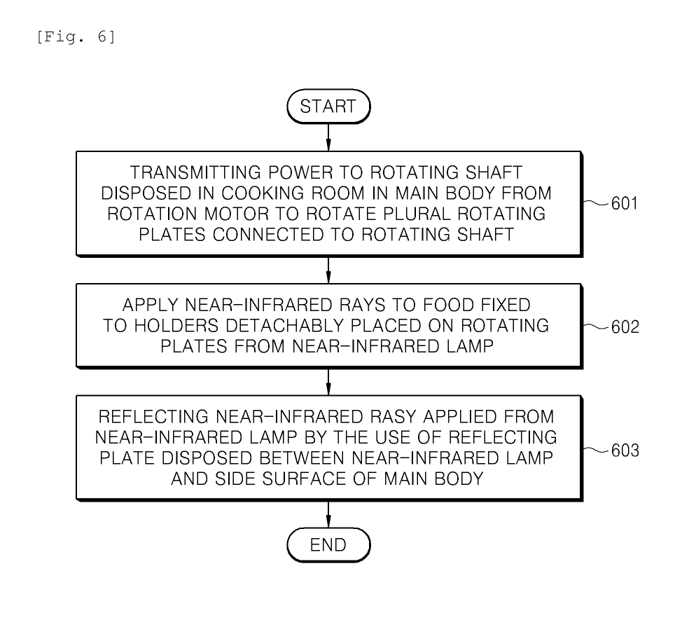

FIG. 6 is a flowchart illustrating an operation method of the food cooking apparatus according to an embodiment of the invention.

As shown in FIGS. 1 and 6, in step 601, the food cooking apparatus 100 first transmits the power to the rotating shaft 103 in the cooking room of the main body 101 from the rotation motor 102 to rotate the plural rotating plates 104 connected to the rotating shaft 103. Accordingly, the near-infrared rays can be evenly applied to the foods 123 put on the rotating plates 104, thereby getting the foods 123 evenly done.

In step 602, the food cooking apparatus 100 applies the near-infrared rays to the foods 123 fixed to the holders 106, which is attachable to and detachable from the rotating plates 104, from the near-infrared lamps 105. At this time, the food cooking apparatus 100 can adjust the brightness of the near-infrared lamps 105 on the basis of the operations of the dimmers 115.

In step 603, the food cooking apparatus 100 reflects the near-infrared rays applied from the near-infrared lamps 105 by the use of the reflecting plates 107 disposed between the near-infrared lamps 105 and the inner side surface of the main surface 101.

On the other hand, the food cooking apparatus 100 combusts the smoking material contained in the smoking material combustion drawer 108 by the use of the near-infrared rays and introduces the smoke generated by the combustion of the smoking material into the cooking room via the introduction holes 109 formed through the top of the smoking material combustion drawer 108.

The food cooking apparatus 100 rotate the fan 118 connected to the fan motor 119 by the use of the fan motor 119, thereby discharging the heat in the cooking room to the outside via the plural heat-dissipating holes 117 formed in the side surface of the main body 101.

The specific embodiments of the invention have been described, but the invention can be modified in various forms without departing from the scope of the invention. Therefore, the scope of the invention is not limited to the above-mentioned embodiments, but is determined by the appended claims and equivalents of the claims.

While the invention has been described with reference to the finite embodiments and drawings, the invention is not limited to the embodiments, but it will be understood by those skilled in the art that the invention can be modified in various forms without departing from the technical spirit of the invention taught from the appended claims. Therefore, the technical spirit of the invention should be read from only the appended claims and the equivalent modifications thereof should belong to the spirit and scope of the invention.

1. A food cooking apparatus comprising:
a main body having a cooking room therein;
a rotation motor transmitting power to a rotating shaft disposed in the cooking room to rotate the rotating shaft;
a plurality of rotating plates being connected to the rotating shaft and rotating by interlocking with the rotation of the rotating shaft;
a holder detachably formed on the tops of the rotating plates, and the holder including a fat receiver receiving fat discharged from the food and a beer container being formed on the fat receiver, containing beer so as to vaporize the beer, and fixing the food thereto; and
a plurality of heaters disposed on the inner side surfaces of the cooking room to generate heat.

2. The food cooking apparatus according to claim 1, wherein each heater is one of a near-infrared lamp emitting near-infrared rays and a gas heater generating heat using gas.

3. The food cooking apparatus according to claim 2, further comprising a plurality of dimmers disposed in a control box on the front surface of the main body to correspond to the number of near-infrared lamps, located at positions corresponding to the near-infrared lamps, and adjusting the brightness of the corresponding near-infrared lamps.

4. The food cooking apparatus according to claim 2, wherein the near-infrared lamps are disposed on both side surfaces in the cooking room.

5. The food cooking apparatus according to claim 2, further comprising reflecting plates disposed between the near-infrared lamps and the side surfaces of the main body and opened toward the near-infrared lamps so as to surround a part of the corresponding near-infrared lamp.

6. The food cooking apparatus according to claim 5, wherein the reflecting plates are formed of aluminum.

7. The food cooking apparatus according to claim 1, further comprising:
a smoking material combustion drawer being formed in a drawer shape containing a smoking material, being disposed in front of the heater at the lowermost out of the heaters, and combusting the smoking material using the heat generated from the heater; and
an introduction hole being formed through the top of the smoking material combustion drawer and introducing smoke into the cooking room.

8. The food cooking apparatus according to claim 7, wherein the smoking material combustion drawer further contains water along with the smoking material, and
wherein the introduction hole introduces steam into the cooking room along with the smoke when the water is vaporized into the steam by the combustion of the smoking material.

9. The food cooking apparatus according to claim 1, further comprising:
a plurality of heat-dissipating holes formed on the side surface of the main body;
a fan discharging the heat of the cooking room through the heat-dissipating holes to the outside; and
a fan motor transmitting power to the fan to rotate the fan.

10. The food cooking apparatus according to claim 1, further comprising:
a room light disposed in the main body to light the cooking room; and
a room light switch disposed in the control box on the front surface of the main body so as to turn on or off the room light.

11. The food cooking apparatus according to claim 1, further comprising a digital thermometer being disposed in the control box on the front surface of the main body, measuring and digitally displaying the temperature of the cooking room, turning off the heaters until the measured temperature is lower than a predetermined temperature when the measured temperature reaches the predetermined temperature.

12. The food cooking apparatus according to claim 1, further comprising casters disposed on the bottom of the main body to move the main body.

13. The food cooking apparatus according to claim 1, further comprising food hangers having a ring shape and being disposed at the edges of the rotating plates so as to hang the food thereon.

14. The food cooking apparatus according to claim 1, further comprising a stand having a plurality of container spaces for containing the food.

15. The food cooking apparatus according to claim 1, wherein the rotating shaft is vertically disposed in the cooking room, and
wherein the rotating plates are arranged at a constant interval to be perpendicular to the rotating shaft.

16. An operation method of a food cooking apparatus, comprising the steps of:
placing a holder including a fat receiver receiving fat discharged from the food and a beer container being disposed on the fat receiver, containing beer so as to vaporize the beer, and fixing the food thereto on a plurality of rotating plates;
transmitting power to a rotating shaft disposed in a cooking room in a main body from a rotation motor to rotate the plurality of rotating plates connected to the rotating shaft;
applying heat to the food fixed to the beer container of the holder detachably placed on the top of each rotating plate by the use of a heater; and
vaporizing the beer contained in the beer container by the use of the applied heat.

17. The operation method according to claim 16, further comprising a step of reflecting near-infrared rays applied from a near-infrared lamp using a reflecting plate disposed between the near-infrared lamp included in the heater and the side surface of the main body, between the step of applying the heat and the step of vaporizing the beer.

18. The operation method according to claim 16, further comprising, between the step of applying the heat and the step of vaporizing the beer, the steps of:
combusting a smoking material contained in a smoking material combustion drawer using the heat; and
introducing smoke generated by the combustion of the smoking material into the cooking room through an introduction hole formed through the top of the smoking material combustion drawer.

19. The operation method according to claim 16, further comprising a step of adjusting the brightness of the near-infrared lamp of the heater by operating a dimmer, between the step of applying the heat and the step of vaporizing the beer.
